(19) United States
(12) Patent Application Publication
(10) Pub. No.: US 2008/0199359 A1
(43) Pub. Date: Aug. 21, 2008

(54) Soil Moisture Sensor

(75) Inventors: Stephen Charles Davis, Queensland (AU); Peter Johnson, Queensland (AU); John Huberts, Queensland (AU)

Correspondence Address: CONNOLLY BOVE LODGE & HUTZ LLP, 1875 EYE STREET, N.W., SUITE 1100, WASHINGTON, DC, 20036, US

(73) Assignee: Senviro Pty Ltd, Brisbane, Queensland (AU)

(21) Appl. No.: 11/994,601

(22) PCT Filed: Jul. 3, 2006
(86) PCT No.: PCT/AU2006/000925

§ 371 Date: Jan. 3, 2008

(30) Foreign Application Priority Data
Jul. 4, 2005 (AU) 2005903513

(51) Int. Cl. G01N 27/00; F17D 3/00

(52) U.S. Cl. 422/82.01; 137/2

(57) ABSTRACT

A soil moisture sensor which includes a processor to derive soil moisture values and a memory store associated with said processor to store measured values on a periodic basis, wherein the processor scales the stored moisture values to establish a moisture range for the sensor that can be used to calibrate each new reading. The sensor includes a capacitive sensor. In one embodiment the processor measures the capacitance at a single frequency and also measures the phase and amplitude to derive measures of soil impedance due to moisture content and conductivity. In another embodiment the soil sensor capacitor is part of a resonant circuit and the resonant frequency of the circuit is measured as an indication of soil moisture. The sensor is constructed on a single substrate, which also functions as its own insertion stake into the soil.

This invention relates to a soil moisture sensor particularly for use with automated watering systems.

### BACKGROUND TO THE INVENTION

U.S. Pat. No. 5,418,466 discloses a soil moisture sensor which measures the capacitance at two distinctly different frequencies of 5-10 MHz and >100 MHz. At the higher frequency, there is little effect on the measured soil impedance from the soil conductivity and the soil impedance is primarily capacitive due to the soil moisture content. At the lower frequency there is significant contribution from the soil conductivity. After taking a measurement with circuits oscillating at different frequency bands the impedance effect due to the conductivity can be obtained by subtraction of the high frequency result from the low frequency result. The high frequency circuit alone can be used to determine soil moisture, but soil conductivity is indicative of the ionic content of the soil, which is in turn indicative of salinity or fertiliser levels present in the soil. There is still some influence of temperature and soil type/structure on the absolute measurement, so soil moisture and conductivity measurements tend to be relative measurements with respect to the environment the sensor is situated in.

U.S. patent application 2004/0095154 discloses the use of phase and amplitude at a single frequency in the range of 40-80 MHz to derive the soil electrical resistance and electrical capacitance. In addition pre-calibration using regression equations with certain soil types is performed after which the probe is moved to a different location having the same soil type and determining these parameters for the new location from the calibration.

It is an object of this invention to provide a soil moisture sensor that is inexpensive and avoids the problems associated with the need for calibration.

### BRIEF DESCRIPTION OF THE INVENTION

To this end the present invention provides a soil moisture sensor which includes
a) a capacitance sensor to measure the capacitance of the soil
b) a processor to derive soil moisture values
c) a memory store associated with said processor to store measured values on a periodic basis
wherein the processor scales the stored moisture values to establish a moisture range for the sensor that can be used to calibrate each new reading.

In this way the processor develops a self learning algorithm that is reliable in providing operational signals to a watering system so that readings that are low on the moisture-scale trigger the watering system and readings that are high do not trigger the system.

The measurement history of the sensor is used to establish upper and lower bounds to normalise the readings for its environment. It is particularly useful in a low cost sensor which only obtains the hybrid conductivity/moisture measurement at one frequency preferably 10 MHz. Although a less accurate indication of the soil moisture, the changes relative to its environment are still useful in determining a “wet” condition of the soil for control of watering systems.

If sufficient history is known predictions can be made of the upper and lower bounds of operation, and by collecting a continuous history changes in the environment and sensor characteristics can be allowed for. This would remove, in many cases, the requirement for calibration and recalibration of the sensor.

The measurement of soil conductivity will be dependant on soil moisture but it is also dependant on soil type, location, dissolved materials, voids, poor placement, etc., and variations over time as the sensor ages. Despite soil conductivity being a relatively straight forward measurement to make, the absolute measurement may be questionable. However if the sensor can establish what the bounds of high and low conductivity are within its particular environment, useful relative information can be derived, for example relating to how fast fertiliser is leaching through the soil. If the sensor can make measurements at multiple depths, these can provide useful profile data.

Similarly as the sensor can learn from the history of its measurements what constitutes the wet and dry bounds, these can be used for continuous recalibration of the sensor. The bounds could be determined using all of the past history with extra weighting applied to more recent measurements. The continuous history need not necessarily be stored as low pass filtering techniques can be used to pick trends.

If a set of measurements of soil conductivity is examined over time, there will be short term maximum and minimum readings of soil conductivity as the soil alternatively dries and is rewet. Similarly there will be the same behaviour in terms of soil moisture.

Each cycle may be different from others in scale but generally will behave similarly.

A maximum reading in any cycle is probably the result of a watering event, and can be correlated with the watering system. Some events will be more significant, i.e. a heavy downpour of rain, or long watering cycle may be sufficient to saturate the soil to the extent that the max possible reading is reached. This reading can be used as a calibration point. The duration of a stable reading is a clue that the soil is saturated, i.e. a short sprinkle over 15 minutes may increase the reading with the shape in the form of values ramping up and then ramping down with short duration flat region at the top. In this case there is no certainty of it being a maximum event whereas a set of readings that ramp-up and then hold their value for a time before ramping down is probably such an event. An advantage of using this method is that the method used in the placement of the sensor in the soil is not so important,

The existence of voids, rocks and other in-homogeneities should not matter as they will be accounted for and filtered out by the algorithm. Even long term changes such a corrosion of the electrodes, circuit deterioration, soil changes and settling will be accommodated to some extent.

The approximate range of the sensor may be pre-set to a broad classification of soil type (e.g. sand, clay etc.) but since the soil at the point of measurement will not have been accurately calibrated for and the measurement will be dependent on other factors such as contact with the soil etc., the idea is for the sensor to learn what the appropriate calibration between wet and dry conditions is for its local environment. This self-learning can have varying degrees of sophistication ranging from application of neural networks to simple algorithms looking for saturation by occurrences of plateaus in the signal region indicating high soil moisture content.

The completely dry reading will be very similar to the reading in air before the probe is inserted. An initial saturation level may be determined for example by instructing the user to water in the sensor when it is first installed, or it could be determined later using historical data from the sensor.

This idea can be further extended by the use of additional sensors buried at different depths at the same location. During a watering event, the shallowest sensor will respond to surface water first and can be used to establish the max reading, deeper sensors will respond slower as there will be a lag in response.

Shallow sensors will respond to changes in conductivity with the application of fertilizer and to leaching out of nutrients (and salt) before deeper levels. This would provide useful data on percolation rates through the soil and leaching rates of fertilizer.

In another aspect the present invention provides a soil moisture sensor which includes a capacitive sensor and a processor which measures the capacitance at a single frequency and also measures the complex attenuation of the signal which is related to phase and amplitude, to derive measures of soil impedance due to moisture content and conductivity.

This is a way of using a low frequency measurement (which in principle can utilise lower cost electronic components) to obtain conductivity information, which in turn is used to derive a more accurate soil moisture measurement. Preferably the complex attenuation of a 10 Mhz signal is used to determine the complex impedance of the sensor in soil.

Solving the two simultaneous equations, equations which describe how changes in sensor capacitance and resistance cause changes in the measured phase and amplitude of a 10 MHz signal resistively coupled to a sensor, is a complex process. To reduce the processing load on the microprocessor (and allow lower cost components to be used), in the sensor electronics a table of solutions can be stored in the sensor's hard wired memory and the sensor need only to interpolate between these solutions to obtain the solution for the measured phase and amplitude.

A lower cost version of the sensor electronics which only measures the amplitude of the 10 MHz signal, may be used in conjunction with a simple conductivity measurement circuit to correct for the conductivity effects convoluted with the moisture measurement. The conductivity measurement may be made using the same sensor operating at a much lower frequency (1 kHz say) since at such low frequencies the capacitive effects of the soil will be masked by the conductive effects. It is still necessary to use an AC signal to measure conductivity as a DC component will cause corrosion and deposition on the electrodes rapidly leading to damage. The 1 KHz sine signal can be generated using PWM techniques within the controlling microprocessor and switched into circuit to replace the 10 MHz signal. The capacitance can then be obtained by applying Pythagoras's theorem from the two measurements.

In another embodiment of this invention, soil moisture is measured by determining the resonant frequency obtained by forming a resonant circuit with the soil moisture sensor capacitor.

In another aspect this invention provides a low cost form of construction. In a preferred embodiment the sensor is constructed on a single substrate, which also functions as its own insertion stake into the soil. An optional wireless transmitter module can also be included in the electronic circuitry and the antenna may also be printed on the same substrate.

There are several manufacturing methods which may be used to achieve this.
1) The sensor is constructed on a conventional printed circuit board (PCB) substrate in the shape of a pointed stake. The circuit tracks and sensor pads are formed by metal etching in the conventional manner. The electronic circuitry occupies the upper part of the PCB area and the sensor pads the lower area. Conventional pick and place and soldering processes are used to populate the board, and the electronic components are then sealed by an appropriate means to protect them from the water/soil environment.
2. Standard PCB construction techniques use lead solder, and are a subtractive process in that chemicals are used to remove copper from the blank PCB. The waste chemicals must be reclaimed for the copper. Copper corrodes in the soil, so the sensor pads must be protected by coating with an inert material like gold.

A plastic substrate may be screen printed with the circuit tracks and sensor pads.

Screen printed circuitry is an additive process in that the conductive and insulating inks are only used where they are needed which reduces the problem of waste and may reduce the material cost of manufacture. Conductive tracks are printed using conductive silver loaded inks which are then over printed with a graphite based protective layer. The graphite layer protects the circuitry from corrosion in the soil and little change seems to occur.
3) The electronic components may be hot embossed directly into the plastic substrate. Connections to the components may then be made by screen printing conductive tracks or addition of conductive tape, and the electronics section completely sealed by thermally welding another plastic layer over the top.

### DETAILED DESCRIPTION OF THE INVENTION

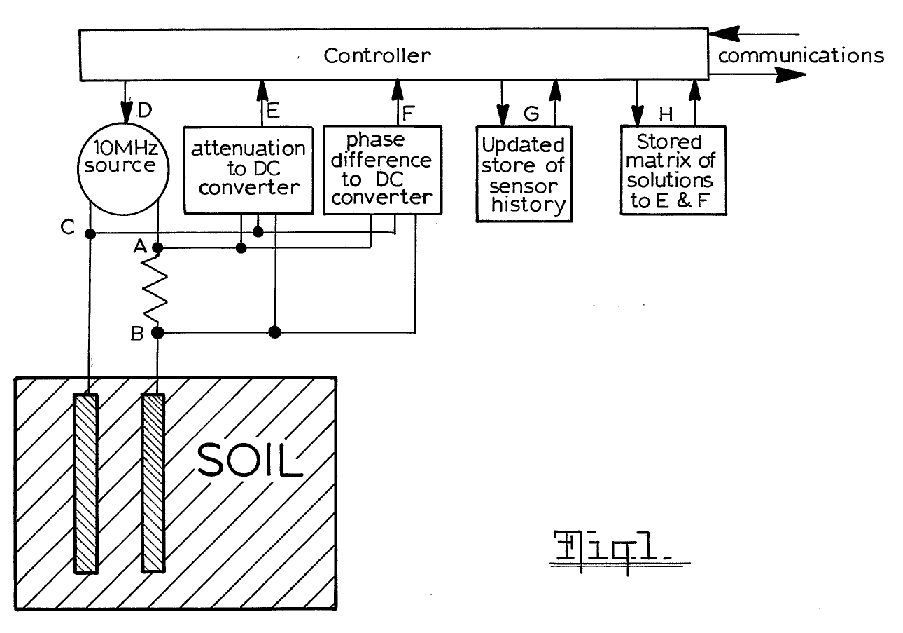

FIG. 1 is a schematic diagram illustrating a soil moisture sensor according to this invention;

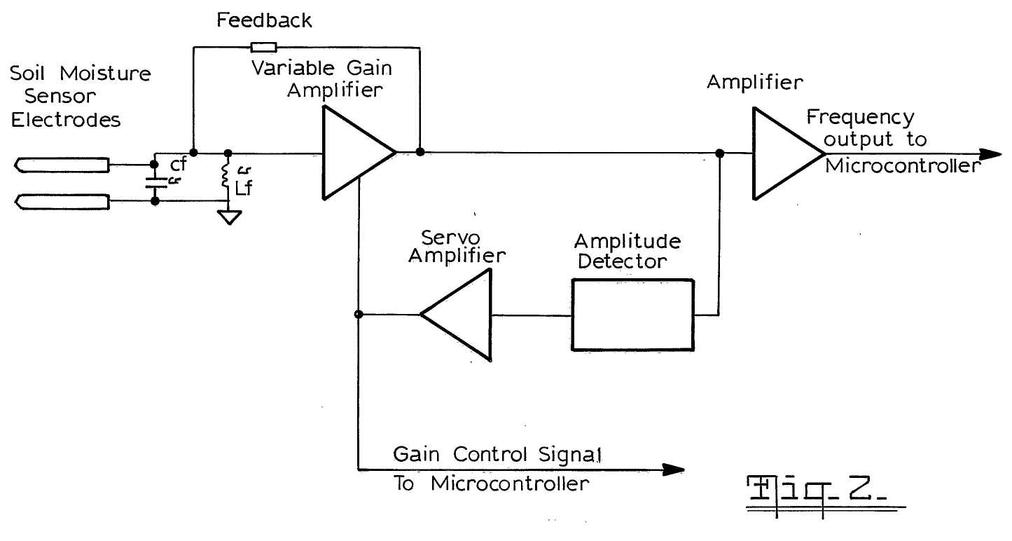

FIG. 2 is a schematic diagram of a second embodiment of this invention;

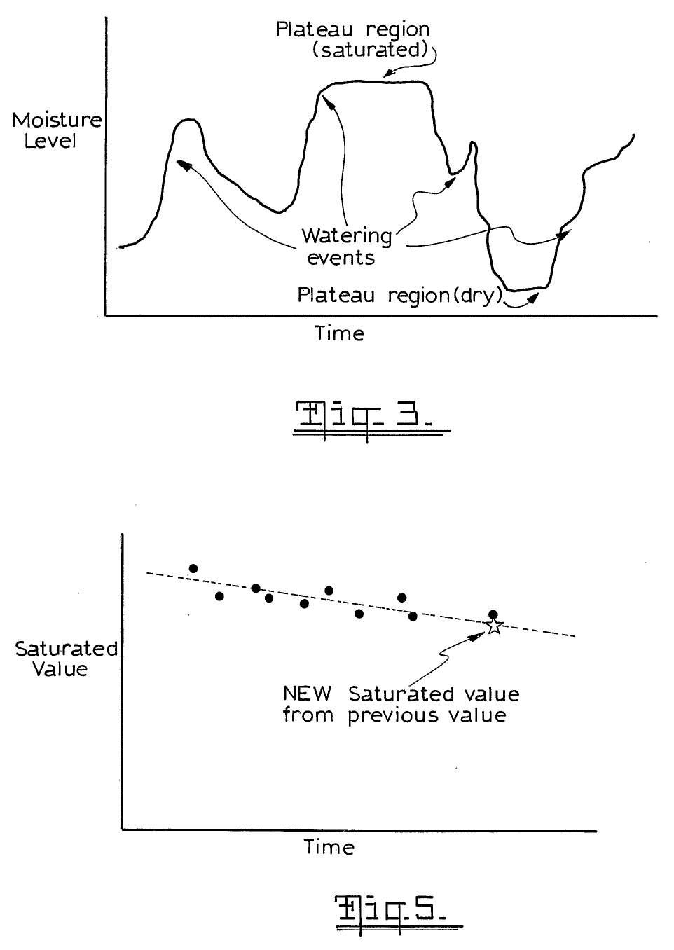

FIG. 3 is a schematic graph illustrating the self learning system of this invention;

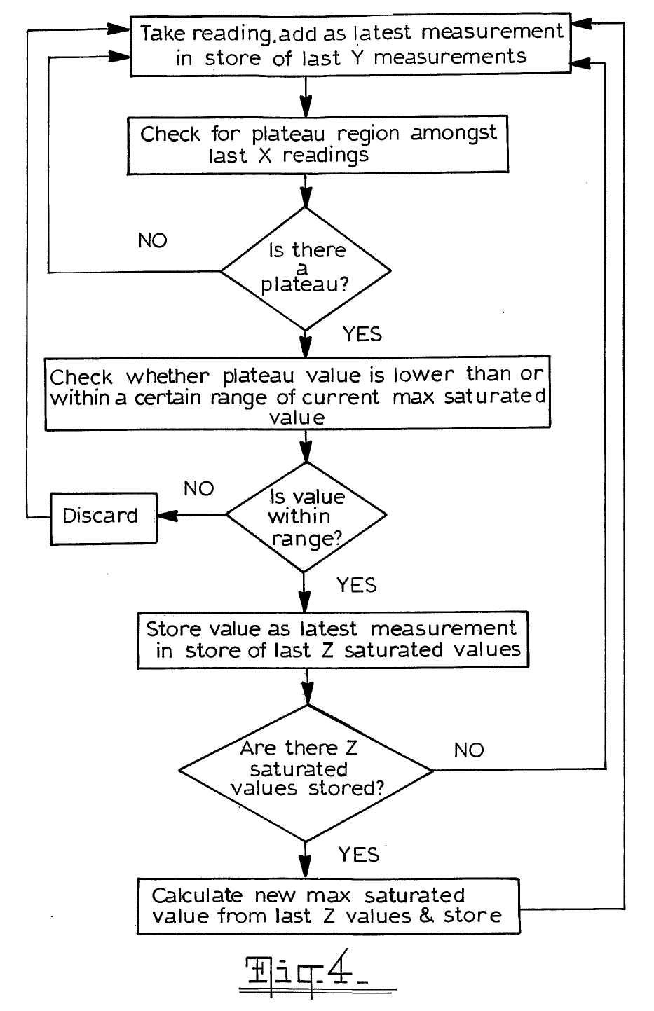

FIG. 4 is flow diagram illustrating the self learning method of this invention;

FIG. 5 illustrates a method of determining the saturated value from previous readings using the self learning method of this invention.

With reference to the system shown in FIG. 1 a 10 Mhz source energises the sensor via a suitable resistor. E is a measure of the magnitude of the attenuation of the source signal(V_{AC}) due to the sensor-soil combination. F is a measure of the phase relationship between the source signal (V_{AC}) and the attenuated signal (V_{BC}) caused by the sensor-soil combination. Used together E and F are a measure of the complex attenuation of the source signal (V_{AC}) caused by the sensor-soil combination. The capacitance and resistance of the sensor-soil combination is determined by using a stored matrix (H) of solutions to the simultaneous equations describing the relationship between the complex attenuation and the complex impedance. The updated history (G) allows the complex impedance to be related to water content for the local conditions. G is updated continuously as the sensor learns about its environment from previous measurements.

A second system for measuring soil moisture and determining complex conductivity is shown in FIG. 2. Conductivity of soil has real and reactive components. The reactive component is capacitive in nature. A resonant circuit may be formed with this capacitive component by parallel connection of inductive and additional capacitive components. The resonant frequency of this circuit is given by:

F=1/(2*pi*(L_{f}*(C_{f}+C_{S})̂0.5)
where L_{f} is a fixed inductance
C_{f} is a fixed capacitance
C_{S} is the capacitance of the soil moisture sensor

If C_{f} is set to a value equivalent to the maximum expected value of C_{S} the resonant frequency will decrease from F when C_{S} is equal 0, to 0.7* F when C_{S} is equal to C_{f}.

An oscillator is formed by connecting the resonant circuit to the input of a variable gain amplifier (VGA) and feedback of the VGA output to the resonant circuit. The oscillating output of the VGA is further amplified to digital signal levels so the frequency may be measured by a micro-controller and the equivalent capacitance of the soil moisture sensor determined.

The real component of soil conductivity dampens the oscillation of the resonant circuit and as it increases the gain of the VGA must be increased in order to sustain oscillation. This is achieved by stabilising the oscillator output amplitude to a fixed level by means of an amplitude detector which measures the output level of the oscillator and a servo loop which adjusts the gain of the VGA. The gain control signal is representative of the real component of soil conductivity.

The self learning system of this invention is graphically illustrated in FIG. 3.

Watering events result in an increase in the measured soil moisture level.

Following the watering event the soil will begin to dry out and the rate of the drying out will be dependent on a number of factors such as how much water was added, how wet the soil was prior to the watering event, the soil type, soil compaction, soil temperature etc. Once the soil becomes saturated the moisture reading will maximise and not increase any further. When this occurs the signal will plateau at a maximum value.

A plateau region could also occur if there is a very slow drying out of the soil, so a history of the moisture data of the soil would be used to compare the value of any plateau region observed with the values of previous maximum plateau values.

Comparison with the previous history of plateau values would then be used in any recalibration of the “100% wet” (fully saturated) value.

An example sequence for determining the new fully saturated values is shown in the flow chart of FIG. 4.

The sequence of FIG. 4 would also apply for determining the completely dry point where minimum moisture values rather than maximum values are used. Default parameters could be stored initially for the max saturated and min dry values based on values for readings in water and air respectively.

A number of methods may be used to calculate the new max saturated value from the last Z stored values. This could for example be by simply averaging or for better time weighting (if the values stored are also time stamped) by fitting a least squares function and determining the new value at each successive addition to the stored saturated values, as shown in FIG. 5.

The self-learning should also be applicable to the simple system where the conductivity is convoluted with the impedance measurement. The effect of adding fertiliser (increased conductivity) would be to increase the value at saturation. In this case the algorithm could look for step changes in the last Z values in the process of re-calculating a new max saturated value. So if a sudden increase were detected it would then check whether subsequent stored saturated values were consistent with this value before re-setting as the new max saturated value.

In the system where both moisture and conductivity data are obtained consideration also needs to be given to calibration and reporting of the conductivity data. The conductivity measured will be dependent on the moisture content of the soil. The nutrient level of the soil is normally inferred from an electrical conductivity (EC) measurement, where the nutrients from a certain volume of soil are extracted into a certain volume of water and the electrical conductivity of the resulting solution is measured. The conductivity reading at full saturation will thus be most akin to the EC reading which would be obtained through the standard analytical procedure. The calibration factor to convert the conductivity measured at saturation by the sensor to an equivalent EC reading can be determined through a series of experiments where both readings are obtained on a set of soil samples.

The relationship between conductivity and soil moisture content is likely to vary with a number of parameters such as soil type. This relationship could also be determined through a self learning process once the sensor is placed in position in the soil. An array of values (e.g. soil moisture, temperature, conductivity) covering the range of interest can be acquired over time, and a calibration function derived.

These values would be obtained during wetting and drying cycles about a saturation event since the saturation event will be best linked to the true EC existing in the soil at that time. Then measurement of the soil moisture, temperature and conductivity can be input to the function to obtain an equivalent EC value at any point. The EC at saturation and the functional relationship could continue to be dynamically updated.

It is within the scope of this invention to download manual settings to the sensor to preset dry, wet and watering thresholds using the communications link. The communications link may be via radio, hardwired or sent via some form of encoding on the power wires.

From the above, those skilled in the art will see that the present invention provides a low cost robust water sensor that overcomes the problems associated with prior art sensor systems. Those skilled in the art will realize that this invention maybe implemented in embodiments other than those described without departing from the essential teachings of this invention.

1. A soil moisture sensor which includes
a) a capacitance sensor to measure the capacitance of the soil
b) a processor to derive soil moisture values
c) a memory store associated with said processor to store measured values on a periodic basis
wherein the processor scales the stored moisture values to establish a moisture range for the sensor that can be used to calibrate each new reading.

2. A soil moisture sensor which includes a capacitive sensor and a processor which measures the capacitance at a single frequency and also measures the complex attenuation of the signal to derive measures of soil impedance due to moisture content and conductivity.

3. A soil moisture sensor which includes a capacitive soil moisture sensor which is part of a resonant circuit and the resonant frequency of the circuit is measured as an indication of soil moisture.

4. A soil moisture sensor as claimed in claim 1 in which the stored moisture values are analyzed for maximum values and when the maximum value is constant it is treated as the value for soil saturation.

5. A soil moisture sensor as claimed in claim 1 in which the stored moisture values are analyzed for minimum values and when the minimum value is constant it is treated as the value for dry soil.

6. A soil moisture sensor as claimed in claim 1 in which the sensor is constructed on a single substrate, which also functions as its own insertion stake into the soil.

7. A soil moisture sensor as claimed in claim 1, wherein the electronic circuitry is embossed into a plastic substrate and electrical connections are made to printed tracks.

8. A method of operating a watering system using the soil sensor defined in claim 1 in which the controller is programmed to
a) analyze the stored moisture values are for maximum values and when the maximum value is constant it is stored as the value for soil saturation
b) analyze the stored moisture values are for minimum values and when the minimum value is constant it is stored as the value for dry soil
c) actuate the watering system when the sensed moisture values approach the minimum value and cease watering when the sensed moisture values approach the maximum value.
